(19) United States
(12) Patent Application Publication
(10) Pub. No.: US 2012/0252265 A1
(43) Pub. Date: Oct. 4, 2012

(54) CONNECTOR ASSEMBLY FOR CORRUGATED COAXIAL CABLE

(75) Inventors: Werner Karl Wild, Buttenwiesen (DE); Noah Montena, Syracuse, NY (US); Brian Hanson, East Syracuse, NY (US); Chris Natoli, Fulton, NY (US)

(73) Assignee: JOHN MEZZALINGUA ASSOCIATES, INC., East Syracuse, NY (US)

(21) Appl. No.: 13/178,397

(22) Filed: Jul. 7, 2011

Related U.S. Application Data
(60) Provisional application No. 61/470,273, filed on Mar. 31, 2011.

(51) Int. Cl. H01R 9/05; H01B 13/20

(52) U.S. Cl. 439/578; 29/828

(57) ABSTRACT

A connector assembly for a corrugated coaxial cable is provided. The coaxial cable connector assembly comprises a compression member having a first end and a second end, a connector body having a first end and a second end, an insulator, a pin, and a spring basket, wherein the first end of the compression member is structured to receive an exposed end of a corrugated coaxial cable and the second end is structured to receive the first end of the connector body, wherein the connector body is configured to retain the insulator therein and the insulator is configured to retain the pin therein to insulate the pin from the connector body, and wherein the spring basket is configured to couple to an exposed inner conductor of the cable, and wherein the compression member is configured to physically retain the cable and electrically couple an outer conductor of the cable to the connector body while electrically coupling the spring basket to the pin.

### CROSS REFERENCE TO RELATED APPLICATION[S]

This application claims priority to U.S. Provisional Patent Application to Wild et al., entitled “CONNECTOR ASSEMBLY FOR CORRUGATED COAXIAL CABLE,” Ser. No. 61/470,273, filed Mar. 31, 2011 the disclosure of which is hereby incorporated entirely herein by reference.

### BACKGROUND

1. Technical Field

This invention relates generally to the field of coaxial cable connectors and more particularly to a contact connector assembly for use with coaxial cables having a center conductor.

2. State of the Art

Corrugated coaxial cables are electrical cables that are used as transmission lines for radio frequency signals. Coaxial cables are composed of an inner conductor surrounded by a flexible insulating layer, which in turn is surrounded by a corrugated outer conductor that acts as a conducting shield. An outer protective sheath or jacket surrounds the corrugated outer conductor.

A corrugated coaxial cable in an operational state typically has a connector affixed on either end of the cable. The quality of the electrical connection between the coaxial cable and the respective connectors is of utmost importance. Indeed, the quality of the electrical connection can either positively or negatively impact the resulting electric signal as well as the performance of the connector. One issue that negatively impacts the electric signal between the cable and the connector is the size of the connector in relation to the size of the cable. Currently, specifically-sized connectors must be chosen for each size of cable that they are to be connected to. Improperly-sized connectors, or even improperly-selected connectors for a certain-sized cable, will negatively impact the electric signal between the cable and the connector, resulting in extremely low performance.

Thus, there is a need in the field of corrugated coaxial cables for a universal connector that addresses the aforementioned problems.

### SUMMARY

The present invention relates to the field of coaxial cable connectors and more particularly to a contact connector assembly for use with coaxial cables having a center conductor.

An aspect of the coaxial cable connector assembly comprises a compression member having a first end and a second end, a connector body having a first end and a second end, an insulator, a pin, and a spring basket, wherein the first end of the compression member is structured to receive an exposed end of a corrugated coaxial cable and the second end is structured to receive the first end of the connector body, wherein the connector body is configured to retain the insulator therein and the insulator is configured to retain the pin therein to insulate the pin from the connector body, and wherein the spring basket is configured to couple to an exposed inner conductor of the cable, and wherein the compression member is configured to physically retain the cable and electrically couple an outer conductor of the cable to the connector body while electrically coupling the spring basket to the pin.

Another aspect of the coaxial cable connector assembly includes the assembly being structured to be assembled in an uncompressed initial first state with the compression member, the connector body, and coaxial cable being physically connected to one another, and the assembly being structured to move from the uncompressed state to a compressed, functionally engaged state wherein the compression member, the connector body, and the coaxial cable are physically and electrically coupled to one another.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is an exploded perspective view of a coaxial cable connector assembly.

FIG. 2 is a cutaway perspective view of the coaxial cable connector assembly.

FIGS. 3a-3b are cutaway perspective views of respective components of the coaxial cable connector assembly.

FIGS. 4a-4c are perspective views of components of the coaxial cable connector assembly.

FIG. 4d is a cutaway perspective view of a component of the coaxial cable connector assembly.

FIGS. 5a-5b are cutaway perspective views of components of the coaxial cable assembly.

FIG. 6 is a cross-sectional side view of a prepared coaxial cable used on connection with the coaxial cable connector assembly.

FIG. 7 is a cross-sectional side view of a coaxial cable connector assembly in a first uncompressed position.

FIG. 8 is a perspective view of components of the coaxial cable connector assembly.

FIG. 9 is a cross-sectional side view of a coaxial cable connector assembly of FIG. 7 in a second compressed position.

FIG. 10 is a magnified, cross-sectional view of the portion indicated in FIG. 9 of the coaxial cable connector assembly in the second position.

FIG. 11 is a cross-sectional side view of an embodiment of the coaxial cable connector assembly in a first position.

FIG. 12 is a cross-sectional side view of the embodiment of the coaxial cable connector assembly of FIG. 11 in a second position.

### DETAILED DESCRIPTION OF EMBODIMENTS

As discussed above, embodiments of the present invention relate to the field of coaxial cable connectors and more particularly to a contact connector assembly for use with coaxial cables having a center conductor.

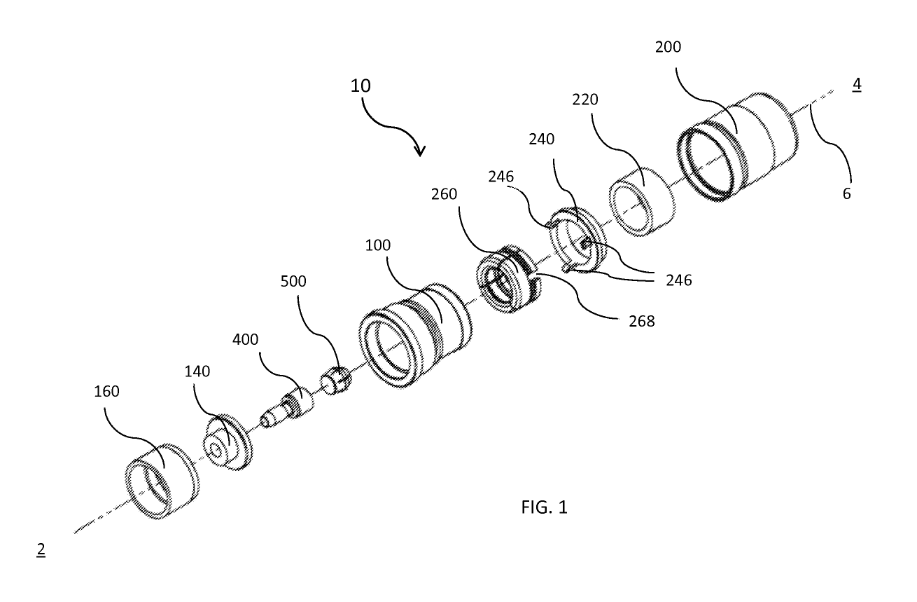

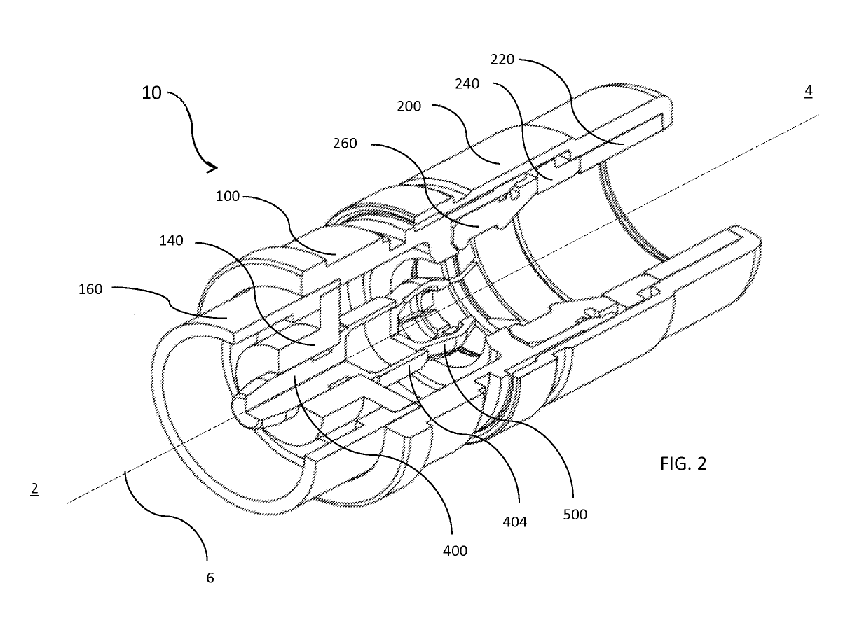

As shown in FIGS. 1 and 2, the coaxial cable connector assembly 10 has a forward end 2 and a rearward end 4 and comprises a connector body 100, a compression member 200, a pin 400, and a spring basket 500. The assembly 10 further comprises a spacer 140, an end ring 160, a grommet 220, a clamp ring 240, and a clamp 260. Each of the above-listed components is axially centered on an axis 6 that substantially coincides with the axial center of a coaxial cable 300. As shown in FIG. 2, under the condition that the connector assembly 10 is assembled, the compression member 200 engages the connector body 100, and the grommet 220, the clamp ring 240, and the clamp 260 are positioned with respect to the compression member 200, and the spacer 140 and the end ring 160 are positioned with respect to the connector body 100. Also, the spacer 140 engages the pin 400, and the pin 400 and the spring basket 500 are structured to engage one another. The engagement of each of the features listed above will be described in further detail below.

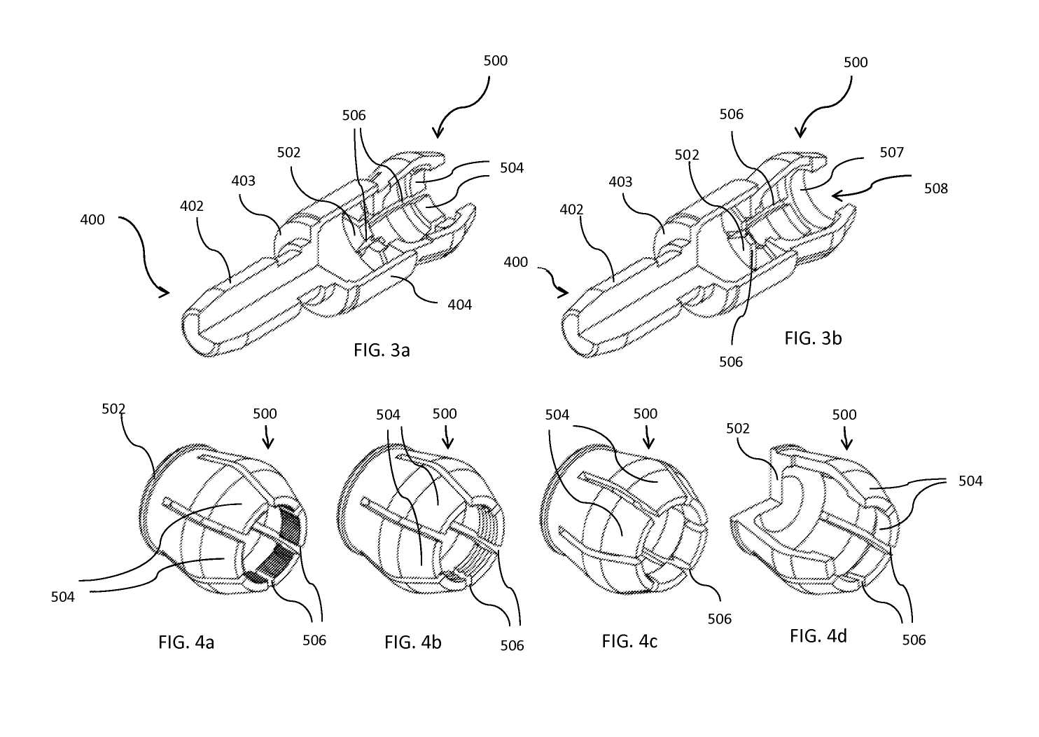

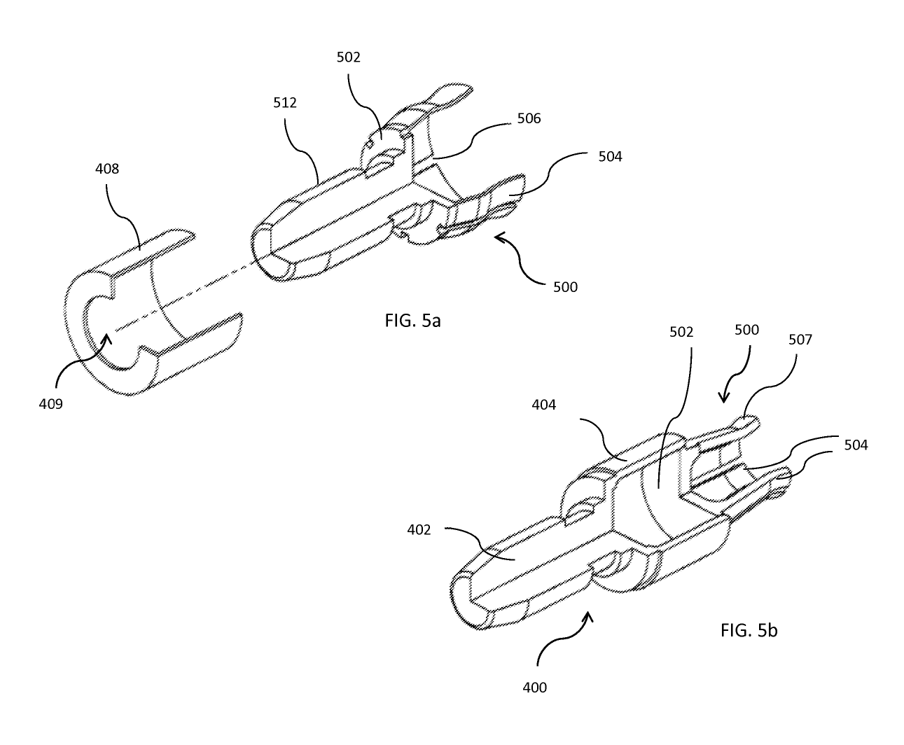

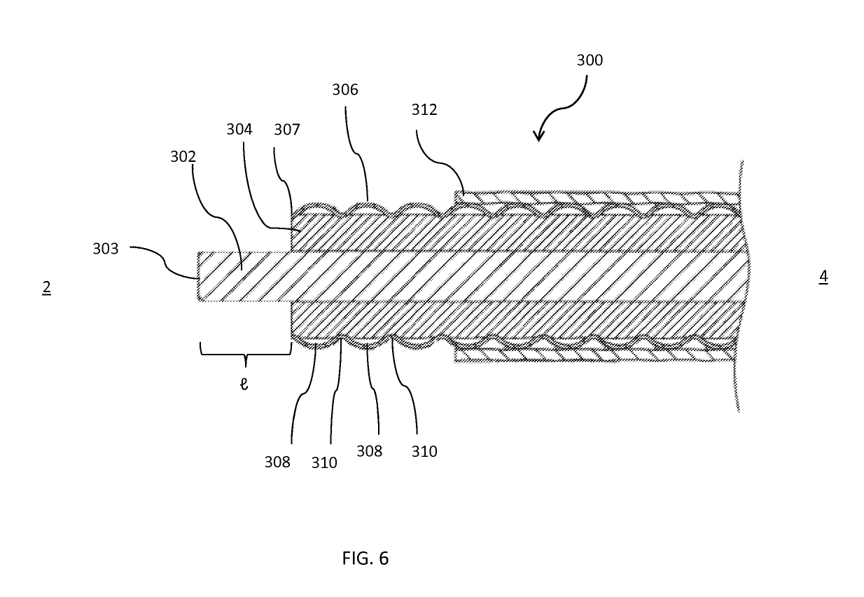

As shown in FIGS. 3a-3b and 4a-4d, the forward end of the pin 400 comprises a cylindrical pin-type protrusion portion 402 and the rearward end of the pin comprises a cylindrical reception portion 404. The junction of the base of the pin-type portion 402 with the reception portion 404 creates a lip 403. The reception portion 404 defines an opening in which a base 502 of the spring basket 500 is inserted. Indeed, the reception portion 404 can be socket-like in shape, such that the basket 500 will be inserted within the socket. For example, the diameter of the base 502 is less than the inner diameter of the socket opening of the reception portion 404 to allow the spring basket 500 to slide into and be retained by the pin 400. As shown in FIGS. 4a-4d, the spring basket 500 can have fingers 504 that project from the base 502. Between these fingers 504 are slots 506 that run from just above the base 502 to the rearward end 508 of the basket 500. The fingers 504 are structured to elastically flex, and exhibit spring-like behavior, in response to pressure forces acting on the fingers 504, the pressure forces stemming from the insertion of the basket 500 into the pin 400. The fingers 504 are flexible enough to be elastically deformed, but are nevertheless firm enough to push back against that which makes it flex. Thus, as the basket 500 is inserted into the socket of the reception portion 404, the fingers 504 flex inward in response to the pressure acting on their respective exterior surfaces. Yet, the spring-like firmness of the fingers 504 allows the respective exterior surfaces of the fingers 504 to push back on the interior surface of the reception portion 404 to maintain solid physical and electrical contact with the interior of the reception portion 404. Moreover, the unique structure of the fingers 504 allows the respective interior surfaces of the fingers 504 to grip the coaxial cable 300 inserted therebetween, as will be described in greater detail below, at the same time that the exterior surfaces of the respective fingers 504 make solid physical and electrical contact with the interior surface of the reception portion 404. The structural configuration of the various components of the assembly 10 and the functional interaction between these components, as described herein, the components including the socket of the reception portion 404 (whether as part of the pin 400 or the spacer 140, as described herein) and the spring basket 500 (whether standing alone or as part of the pin 400, as described herein), are the means for compressing the fingers 504 of the spring basket 500 about an exposed inner conductor 302 of a coaxial cable 300 inserted therein.

Additional embodiments of the basket 500 include the interior surfaces of the fingers 504 having axially oriented ribs, as shown in FIG. 4a, having circumferentially oriented ribs, as shown in FIG. 4b, and having no additional ribs, as shown in FIG. 4c. As shown in FIG. 4d, the base 502 can be a solid, closed-end surface. In additional embodiments, as shown in FIG. 3a, the spring basket 500 may have a base 502 that has slots 506 positioned therein to allow expansion or compression of the base 502 during insertion into the pin 400. The slots 506 in the base 502 may be in addition to the slots between the fingers 504. In this case, the slots 506 in the base 502 alternate in orientation to the slots 506 between the fingers 504, so that the basket 500 maintains its functional and structural integrity. In yet another alternative embodiment, as shown in FIG. 3b, the base 502 can have slots 506 positioned therein to allow expansion and contraction of the base 502, whereas the rearward end 507 of the basket 500 can be a solid end piece having a center opening 508 for receiving a portion of the coaxial cable 300. In this case, the slots 506 in the base 502 continue up and around the sides of the basket 500 until the slots 506 reach the solid end piece of the rearward end 507. Thus, the solid end piece of the rearward end 507 maintains the functional and structural integrity of the basket 500.

In additional embodiments, as shown in FIGS. 5a-5b, the spring basket 500 can have attached thereto, or formed therewith, as shown in FIG. 5a, a cylindrical pin-type protrusion 512. In other words, the basket 500 can have the cylindrical pin-type protrusion 512 that extends from the base 502 of the basket, and is similar to the cylindrical pin-type protrusion 402, discussed above. In this embodiment, a compression ring 408 that has a center opening 409 defined in a forward end of the ring 408 can slide over the protrusion 512 and engage the fingers 504 of the basket 500 much in the same way that the reception portion 404 of the pin 400 engages the fingers 504. In the embodiment disclosed in FIG. 5b, under the condition that the pin 400 is slid over the basket 500, the basket 500 is engaged by the reception portion 404 of the pin 400, such that the fingers 504 flex inward to grip a portion of the coaxial cable 300 inserted between the fingers 504 of the basket 500. The structural configuration of the fingers 504 in this embodiment is different than the structural configuration of the fingers 504 described above with respect to FIGS. 3a-4d, as the fingers 504 in this embodiment initially flare inward from the base 502 and the rearward end 507 of the basket flares outward to engage the reception portion 404 of the pin 400. In the embodiments described above with respect to FIGS. 3a-4d, the fingers 504 initially flare outward with the rearward end 507 flaring inward. Nevertheless, the fingers 504 in the alternative embodiments are each structured to engage both the interior surface of the reception portion 404 and the portion of the coaxial cable 300 inserted inside the fingers 504.

The expandability, or flex, of the fingers 504 of the basket 500 accommodates use of the connector assembly 10 with coaxial cables categorized as the same size and shape but which have an inner conductor 302 that ranges in actual dimensions. Indeed, the uniformity in diameter of the inner conductor 302 in coaxial cables manufactured by different manufacturers varies from manufacturer to manufacturer. Thus, although classified as the same size, the inner conductor 302 of the coaxial cable obtained from different manufacturers may vary enough in actual size to adversely impact the performance of the cable and the connector attached thereto. However, the flex of the fingers 504 of the basket 500 provide a suspension-like effect that makes up for and corrects the slight variations in the diameter of the inner conductor 302 supplied by different manufacturers. Indeed, the constant inner diameter of the socket of the reception portion 404 of the pin 400 causes the fingers 504 on the spring basket 500 that are inserted into the reception portion 404 to flex and elastically deform as needed to achieve and maintain proper functional contact with the inner conductor 302 placed within the basket 500. In this way, even slight variations in diameter of the inner conductor 302 can be corrected by the fingers 504 to ensure proper and adequate electrical coupling of the inner conductor 302 and the pin 400.

As shown in FIG. 6, the coaxial cable 300, mentioned above, is prepared to be inserted into the basket 500 and further into the coaxial cable connector assembly 10. The coaxial cable 300 has the inner conductor 302 mentioned above, an insulating layer 304, a corrugated outer conductor 306, and an outer protective sheath, or jacket, 312. The inner conductor 102 is positioned at the core of the coaxial cable 300. The insulating layer 304 surrounds the inner conductor 302, and generally serves to support the inner conductor 302 and insulate the inner conductor 302 from the corrugated outer conductor 306. The corrugated outer conductor 306 surrounds the insulating layer 304, and generally serves to shield the inner conductor 302 from the electromagnetic radiation attempting to reach or emanating from the inner conductor 302. The corrugated outer conductor 306 can be formed from solid copper, solid aluminum, or copper-clad aluminum (CCA), although other conductive materials are also possible. The corrugated outer conductor 106 has alternating peaks 308 and valleys 310 that allow the coaxial cable 300 to be flexed. The jacket 312 surrounds the corrugated outer conductor 306, and generally serves to protect the internal components of the coaxial cable 300 from external contaminants, such as dust, moisture, and oils, or the like. The jacket 312 can be formed from a variety of materials including, but not limited to, polyethylene (PE), high-density polyethylene (HDPE), low-density polyethylene (LDPE), linear low-density polyethylene (LLDPE), rubberized polyvinyl chloride (PVC), or some combination thereof.

To prepare the coaxial cable 300 for assembly in the coaxial cable connector assembly, a user will cut the coaxial cable 300 to provide a clean end. The user will then remove a portion of the jacket 312, the outer conductor 306, and the insulating layer 304 to expose a length of the inner conductor 302. Also, the user will cut the outer conductor 306 at a portion within one of the valleys 310 in the outer conductor 306. The length t of the center conductor 302 that is left exposed should be at least as long as the spring basket 500 is deep, but the exposed length of the center conductor 302 should not be much longer than the spring basket 500 is deep. This is due to the fact that during assembly of the coaxial cable connector assembly 10, the exposed end of the inner conductor 302 will be inserted into the spring basket 500 so that the forward end 303 of the inner conductor 302 contacts the base 502 of the basket 500 so that the fingers 504 surround the exposed length of the inner conductor 302 and extend down the exposed length until they almost reach the insulating layer 304. Then, once the assembly 10 is coupled in its functionally engaged state, as will be described in greater detail below, the fingers 504 will evenly grip and retain the exposed end of the inner conductor 302 along the entire length of the basket 500. Such a configuration provides an advantageous electrical connection between the spring basket 500, and thus the coaxial cable connector assembly 10, as described below, and the coaxial cable 300. Once the proper length of the inner conductor 302 is exposed, and the outer conductor 306 has been cut in one of the valleys 310, such that the forward end of the exposed outer conductor 306 is in contact with the outer surface of the insulating layer 304, the user will remove an additional length of the jacket 312 to expose the first three successive peaks 308 of the outer conductor 306. Once prepared, the coaxial cable 300 can be electrically and physically coupled with the assembly 10.

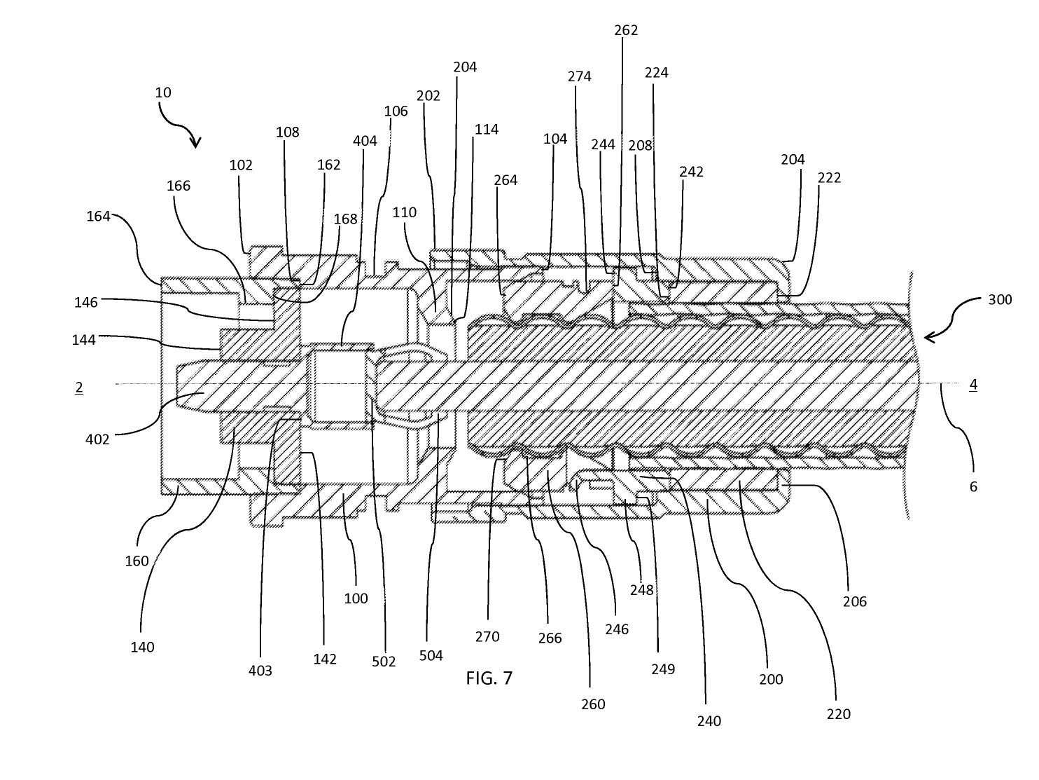

As shown in FIG. 7, the assembly 10 is assembled in a first initial state. The connector body 100 is generally cylindrical in shape and has a hollow center for housing the pin 400 and receiving the spring basket 500 coupled to the inner conductor 302 of the coaxial cable 300. The connector body 100 includes a rearward end 104, a forward end 102, a groove 106 on the outer periphery of the connector body 100, an inner shoulder 108 on the inner surface of the connector body 100, and an inner protrusion 110 protruding from the inner surface of the connector body 100 toward the axial center of the assembly 10. The forward end 102 of the connector body 100 is structurally configured to be disposed over a portion of the end ring 160 and at least over the rearward end 162 of the end ring 160. In the first state, the inner shoulder 108 is structured to abut the rearward end 162 of the end ring 160. The end ring 160 and the connector body 200 may be engaged by a nut (not shown), such that axial advancement of one of the end ring 160 and the connector body 100 produces axial advancement of the other. Thus, when axial advancement of the connector body 100 is described or referred to herein, axial advancement of the end ring 160, the insulator 140, and the pin 400 is also contemplated.

The groove 106 in the connector body 100 is structured to house an o-ring (not shown) for sealing the assembly 10 in a functionally engaged state, to be discussed in detail below. The inner protrusion 110 has a rearward facing face 111 thereof, a portion of which has an angled surface 112 that angles toward the rearward end 4 of the assembly 10. The angled surface 112 has a terminal point 114 at its outermost extremity.

The end ring 160 is generally cylindrical in shape and has a hollow center portion. In addition to the rearward end 162, the end ring 160 further includes an inner ridge 166 on the inner surface of the end ring 160, the inner ridge 166 having a rearward end 168.

The spacer 140 is an insulator. The spacer 140 is generally cylindrical in shape and has a hollow center portion for receiving and retaining the cylindrical pin-type portion 402 of the pin 400. The spacer 140 has a rearward end 142, a forward end 144, and a planar surface 146. Under the condition that the spacer 140, the end ring 160, and the pin 400 are in the first state of FIG. 7, the lip 403 of the pin 400 abuts the rearward end 142 of the spacer 140 and the planar surface 146 of the spacer 140 abuts the rearward end 168 of the inner ridge 166 of the end ring 160. As mentioned above, the spacer 140 can be an insulator to insulate the pin 400 from the end ring 160 and the connector body 100.

The compression member 200 is generally cylindrical in shape and has a hollow center for receiving the coaxial cable 300. The compression member 200 has a forward end 202 and a rearward end 204, the rearward end 204 may include a flange 206 that extends radially inward from the rearward end 204 toward the axial center of the assembly 10 to define a diameter in the rearward end 204 that is configured to receive the coaxial cable 300. In certain embodiments, the diameter of the rearward end 204 is configured to receive a ½″ coaxial cable. The forward end 202 of the compression member 200 is structurally configured to be disposed at least partially over the outer periphery of the connector body 100 and at least over the rearward end 104 of the connector body 100. However, those in the art should appreciate that embodiments of a compression member 200 may be operably configured in a manner such that the compression member 200 is sized and shaped so as to be inserted into at least a portion of the connector body 100. The compression member 200 further includes an inner shoulder 208 on the inner surface of the compression member 200.

The grommet 220 may be generally cylindrical in shape and, in the embodiment shown in FIG. 7, positioned within the rearward end 204 of the compression member 200 in the first state. The grommet has a rearward end 222 and a forward end 224. The grommet 220 is configured to reside between the interior surface of the compression member 200 and the jacket 312 of the coaxial cable 300, the rearward end 222 abutting the flange 206 of the compression member 200 and the forward end 224 abutting the clamp ring 240. Also, the grommet 220 may be made of an elastomeric material, such as silicone rubber, such that the grommet 220 can deform, even compress, under the condition that the assembly 10 is in the functionally engaged state, as will be described in detail below.

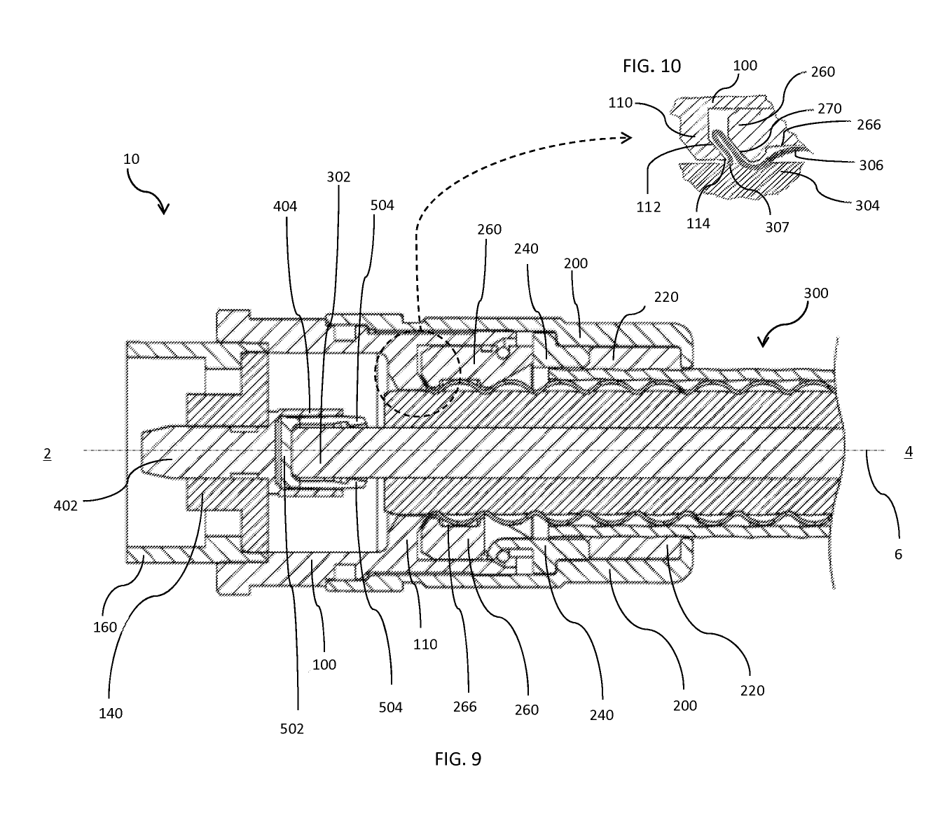

The clamp ring 240 may be generally cylindrical in shape and has a center bore therethrough. The center bore defines an interior diameter. The clamp ring 240 further comprises a rearward end 242 and a forward end 244, the rearward end 242 abutting the forward end 224 of the grommet 220 in the first state. The clamp ring 240 further comprises a hook 246 protruding off the front face of the forward end 244, as shown in FIG. 1. In the embodiment shown, the clamp ring 240 comprises three hooks 246 spaced equidistant around the circumference of the face of the forward end 244. The hooks 246 have a base that rises off the front face of the forward end 244 near the interior diameter defined by the center bore. From the base, the hooks 246 hook radially outward, but the hooks 246 do not extend beyond the outer radius of the outer periphery of the clamp ring 240. The clamp ring 240 further comprises an outer ridge 248 that runs around the circumference of the clamp ring 240 and is positioned approximately mid-span on the outer periphery of the clamp ring 240. The outer ridge 248 may be in tactile communication with the inner surface of the compression member 200 for guidance during compression of the assembly 10. Also, a rearward surface 249 of the outer ridge 248 is configured to abut the shoulder 208 of the compression member 200 under the condition that the assembly 10 has been compressed to its functional engaged state. As seen in FIG. 9, the rearward surface 249 of the outer ridge 248 contacts the shoulder 208 during compression of the assembly into its functional engaged state to prevent the grommet 220 from being over compressed.

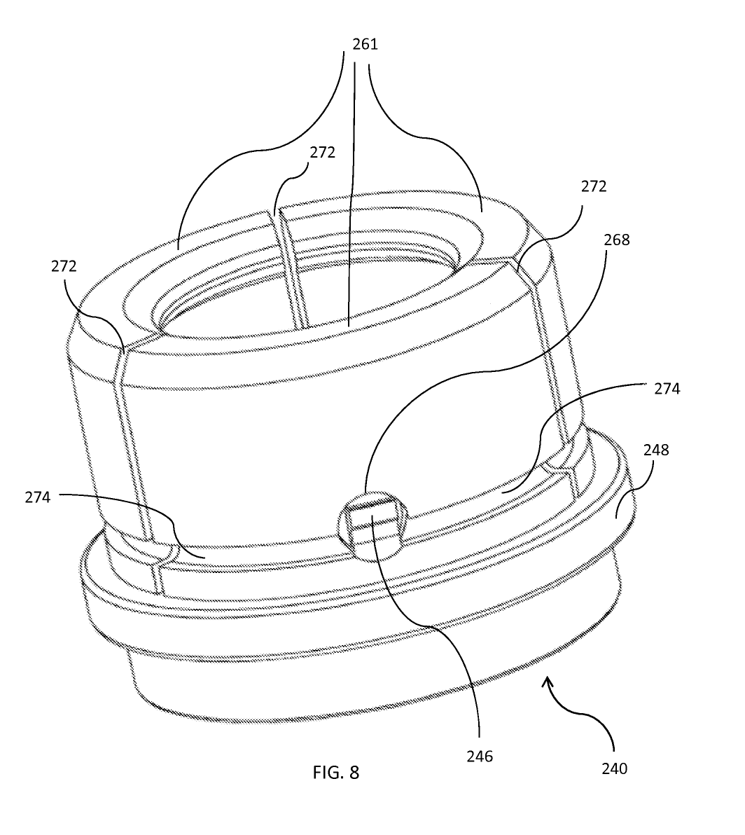

The clamp 260 comprises a rearward end 262, a forward end 264, and defines a hollow bore therebetween. In certain embodiments, the clamp 260 is comprised of three separate pieces 261 that are identical in structure. These three separate pieces 261 can be placed together to form the annular-shaped clamp 260 shown in FIGS. 1 and 8. The three separate pieces 261 define therebetween slits 272. These slits 272 allow the pieces 261 of the clamp 260 to move with respect to one another under force. Specifically the slits 272 allow the three separate pieces 261 to radially displace with respect to one another in response to the forces acting thereupon. For example, during assembly of the connector assembly 10, the coaxial cable 300 is inserted into the compression member 200 and through the clamp 260. In response, the individual pieces 261 of the clamp 260 radially displace with respect to one another to allow the peaks 308 of the outer conductor 306 to pass therethrough. The individual pieces 261 then radially contract or relax with respect to one another as the valleys 310 of the outer conductor pass therethrough. This action is repeated until an interior channel 266 of the clamp 260, to be discussed in greater detail below, resides over the second peak of the exposed peaks 308. Also, during final compression, the connector body 110 slides over the outer periphery of the clamp 260 and causes the individual pieces 261 of the clamp to radially inwardly displace with respect to one another to compress against the outer conductor 306 to hold it in place and make sufficient electrical contact with the outer conductor 306.

The individual pieces 261 of the clamp 260 further comprise axial holes 268 in the face of the rearward end 262. The holes 268 are axially aligned parallel with the axis 6 of the assembly 10 and are structurally configured to receive the hooks 246 of the clamp ring 240. In the first state, the hooks 246 slide into and functionally engage the holes 268 in the clamp 260. The clamp 260 further comprises a groove 274 in the outer periphery of the clamp 260, the groove 274 being capable of housing an o-ring, as shown in FIG. 9, that holds the pieces 261 together with respect to one another to form the clamp 260. Also, the groove 274 is cut to a depth to expose a side portion of the axial holes 268. In this manner, each individual piece 261 of the clamp 260 can be placed over a respective hook 246 of the clamp ring 240. Thereafter, the o-ring can be inserted into the groove 274 such that the hook portion of the hooks 246 wraps, or hooks, over the o-ring and engages the o-ring, thus securing the clamp ring 240 to each piece 261 of the clamp 260, and vice versa. Thus, the functional interaction of the o-ring and the hooks 246 aid in retaining the individual pieces 261 of the clamp 260 together with the clamp ring 240.

As shown in FIGS. 7 and 9, the inner surface of each piece 261 of the clamp 260 defines an interior channel 266 of the clamp 260, the edges of the channel 266 and the size and shape of the channel 266 being structurally configured so as to conform to the size and shape of the surfaces of the corrugation peaks 308 and corrugation valleys 310 of the segment of coaxial cable 300. For example, the channel 266 can be configured to make physical and/or electrical contact with the peaks 308 and valleys 310 of the outer conductor 306 of the cable 300. As shown, the interior of the channel 266 is structured to engage one of the peaks 308, whereas the edges of the channel, or the exterior of the channel 266, is structured to engage the valleys 310 on either side of the particular peak 308 engaged by the interior of the channel 266. The particular function of the channel 266 and the purpose of the structure thereof, will be described in greater detail below.

The forward end 264 of the clamp 260 further comprises an angled engagement surface 270 that is structurally configured to engage the angled surface 112 of the connector body 100 under the condition that the assembly 10 is in its compressed functional engaged state. Indeed, because the angled surface 112 angles toward the rear of the assembly 10, the angled engagement surface 270 is also angled rearwardly at substantially the same angle as the angled surface 112, so as to be able to functionally engage the angled surface 112.

The connector assembly 10 can be assembled in the following manner. The connector assembly 10 is pre-assembled to its first axial position, as shown in FIG. 7. This is done by assembling the compression member 200 and its related components 220, 240, and 260. The grommet 220 is inserted into the compression member 200 until the rearward end 222 of the grommet 220 abuts the flange 206. The clamp ring 240 is assembled with each piece 261 of the clamp 260, as described above, and the assembled clamp ring 240 and clamp 260 are inserted into the bore of the compression member 200 until the rearward end 242 of the clamp ring 240 abuts with the forward end 224 of the grommet 220.

The connector assembly 10 may then be joined to the coaxial cable segment 300 in the following manner. The corrugated coaxial cable segment 300 may be prepared for insertion by cutting the cable at one of the corrugation valleys 310, as described with respect to and as shown FIG. 6. This offers an advantage over many prior art cable connectors that require cutting the corrugation at a peak, which can be difficult. The cable 300 is then inserted through the rearward end 222 of the compression member 200 and pushed through the compression member 200, through the grommet 220, through the clamp ring 240 and through the clamp 260, until the second peak of the three exposed peaks 308 is engaged by the inner channel 266 of the clamp 260. While the peaks 308 and the valleys 310 of the cable 300 are passing through the clamp 260, the individual pieces 261 of the clamp 260 radially displace with respect to one another, as described above. Specifically, the peaks 308 of the outer conductor 306 cause the individual pieces 261 of the clamp 260 to outwardly radially displace as the peaks 308 pass therethrough, whereas as the valleys 310 pass therethrough the o-ring in the groove 274 provides enough elastic retention on the pieces 261 to cause the pieces 261 of the clamp 260 to inwardly radially displace with respect to one another. Thus, the clamp 260 is able to radially displace to allow the outer conductor 306 to be placed in its proper preassembled shape with the second exposed peak 308 residing with the inner channel 266. Moreover, the hooks 246 on the clamp ring 240 prevent the pieces 261 of the clamp 260 from axially displacing with the axial movement of the coaxial cable 300 during insertion of the cable 300 into the assembly 10. Specifically, because the hooks 246 of the clamp ring 240 engage the o-ring that is secured in the groove 274 of the clamp 260, the clamp ring 240 retains the clamp 260 in a suitable position during insertion of the coaxial cable 300 in the assembly 10.

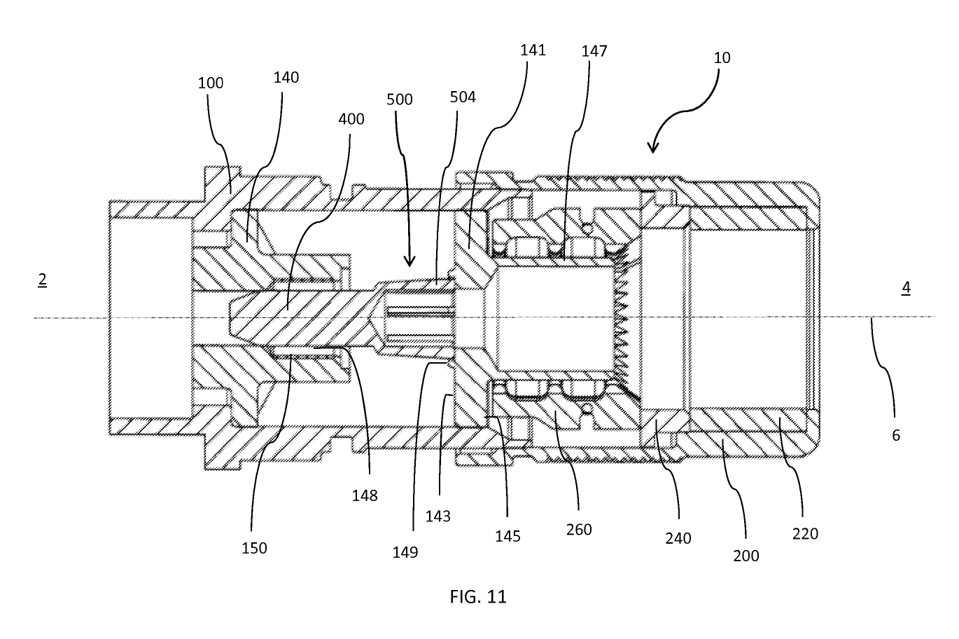

Once the coaxial cable 300 has been properly inserted into the compression member 200 and its related components, as described above, the spring basket 500 may then be inserted onto the exposed forward end 303 of inner conductor 302 of the cable 300, as shown in FIG. 7. In embodiments where the spring basket 500 comprises the pin-type protrusion 512, the spring basket 500 having the pin-type protrusion 512 connected thereto can be inserted onto the exposed end 303 of the inner conductor 320. Alternatively, the pin-type protrusion 512 could be inserted into the spacer 140 prior to the spring basket engaging the exposed end 303 of the inner conductor 320. As shown in FIG. 11, the pin 400 having the spring basket 400 integral thereto can inserted into the spacer 140 prior to the assembly 10 being axially advanced into the functionally engaged state. Yet, despite the alternative embodiments, the pin 400 (or pin-type protrusion 512) is configured to engage the spacer 140 while the basket 500 is configured to engage the exposed end 303 of the inner conductor 320 in the functionally engaged state of the assembly 10.

The connector body 100 and its related components, 140, 160, and 400 can be assembled according to the following exemplary embodiment, as shown in FIG. 7. The pin-type portion 402 of the pin 400 can be inserted through the bore of the spacer 140, such that the lip 403 of the pin 400 abuts with the rearward end 142 of the spacer 140. The spacer 140 can then be inserted into the end ring 160 by abutting the planar surface of the spacer 140 with the rearward end 168 of the inner ridge 166 of the end ring 160. The end ring 160, the spacer 14 and the pin 400 are together inserted into the connector body 100 by inserting the end ring 160 into the forward end 102 of the connector body 100 such that the outer periphery of the rearward end 162 of the end ring 160 slides into the inner diameter of the forward end 102 of the connector body 100 until the rearward end 162 abuts with the shoulder 108 of the connector body 100.

Thereafter, the connector body 100 with its related components and the compression member 200 with its related components, are assembled together by axially slidably engaging the rearward end 104 of the connector body 100 within the forward end 202 of the compression member 200, such that the connector body 100 slides into and within the interior of the compression member 200 until the reception portion 404 of the pin 400 begins to engage the base 502 of the spring basket 500, as shown in FIG. 7. In this manner, the connector assembly 10 is assembled in its initial first state and is ready to be axially advanced to its functionally engaged state.

As shown in FIG. 9, the assembly 10 has been slidably engaged into its functionally engaged state, wherein the assembly 10 is physically and electrically engaged with the coaxial cable 300, such that the electrical signal passing through the coaxial cable 300 also passes through the assembly 10 to allow the assembly 10 to thereafter be functionally engaged to a corresponding connector or port to pass the electrical signal thereto or therethrough. To place the assembly 10 into its functionally engaged state, a user may manually, or by a provided tool (not shown), axially advance the compression member 200 and the body 100 toward one another from the first uncompressed state until the proper physical and electrical coupling of the assembly 10 is obtained in the functionally engaged state.

Specifically, to reach the functionally engaged state, the compression member 200 and the body 100 can be axially advanced to eventually force the reception portion 404 of the pin 400 to physically surround and electrically engage the base 502 and fingers 504 of the spring basket 500, such that the coaxial cable 300 becomes electrically and physically coupled to the assembly 10. By physically engaging the end ring 160 and forcing it axially toward the compression member 200, the end ring 160 physically engages both the connector body 100 and the spacer 140, which also engages the pin 400, and slides each component axially toward the rearward end of the assembly 10. On the opposing side, by physically engaging the compression member 200 and forcing it axially toward the connector body 100, the compression member 200 physically engages the grommet 220, which engages the clamp ring 240, which engages the clamp 260, which engages the outer conductor 306 of the cable 300 and drives the coaxial cable 300 forward toward the forward end 2 of the assembly 10 and simultaneously drives the compression member 200 over the connector body 100. As the coaxial cable 300 slides axially toward the forward end 2 of the assembly 10, the base 502 of the spring basket 500 enters the open end of the reception portion 404 of the pin 400. The spring basket 500 slides within the reception portion 404 of the pin 400 and the outer periphery of the fingers 504 electrically engage the inner surface of the reception portion 404 of the pin 400. At the same time, the inner surfaces of the respective fingers 504 physically and electrically engage the inner conductor 302. As mentioned above, the spring-like flex of the fingers 504 allows the fingers 504 to functionally engage varying diameters of the inner conductor 302 and provide proper electrical coupling from the inner conductor 302 to the pin 400. Also, as the compression member 200 is slid toward the forward end 2 of the assembly 10, the forward end 202 of the compression member 200 slidably engages the o-ring (not shown) in the groove 106 on the outer periphery of the compression member 200 and seals the inner components of the assembly 10 from outside moisture and contaminant ingress.

In addition to the above, as the assembly 10 is moved from its first state, FIG. 7, to its functionally engaged state, FIG. 9, a leading edge 307 of the corrugated outer conductor 306 encounters the terminal point 114 of the angled surface 112 of the connector body 100. As the leading edge 307 makes contact with the angled surface 112, the exposed corrugated outer conductor 306 is deformed in a manner that provides superior electrical contact. Recalling that the outer conductor 306 has been trimmed at a corrugation valley 308, in one embodiment the angled surface 112 and corresponding angled surface 270 of the clamp 260 cause the outer conductor 306 to fold upon itself and become wedged between the respective angled surfaces 112 and 270. The folding action creates two thicknesses of conductive outer conductor 306, which significantly improves electrical contact. FIG. 10 illustrates the folded conductor 306 in an enlarged view. The angled surfaces 112 and 270, the terminal point 114, and the folded outer conductor 306 are depicted in slightly exploded view to delineate the various components. In actuality, the components are tightly compressed together. The structural configuration of the various components of the assembly 10 and the functional interaction between these components, including axial advancement and radial displacement of the various components as described herein, the components including the angled surfaces 112 and 270, as described herein, are the means for compressing the outer conductor 306 of the cable 300 between the angled surfaces 112 and 270.

As a result, in the functionally engaged state of FIG. 9, the inner conductor 302 of the cable 300 is physically and electrically coupled to the pin 400. Also, the outer conductor 306 of the cable 300 is physically and electrically coupled to the compression member 200 and the connector body 100. The spacer 140 insulates the pin 400 from the end ring 160 and the connector body 100.

In addition to the electrical coupling of the assembly 10, the arrangement of components of the assembly 10 provide frictional forces to physically lock the connector assembly 10 in place. Several components of the assembly 10 are configured to provide slight radial interference (RIF) with one another. For example, the outer diameter of the clamp 260 and the inner diameter of the connector body 100 are sized to provide a slight RIF with each other, the outer diameter of the connector body 100 and the inner diameter of the compression member 200 are sized to provide a slight RIF with each other, the outer diameter of the end ring 160 and the inner diameter of the connector body 100 are sized to provide a slight RIF with each other, the outer diameter of the pin-type portion 402 of the pin 400 and the center bore of the spacer 140 are sized to provide a slight RIF with each other, and the inner diameter of the receiving portion 404 and the outer diameter of the spring basket (including the fingers 504) are sized to provide a slight RIF with each other. In concert with these RIF frictional forces, many radially-directed forces, including the forces exerted on the outer conductor 306 by the clamp 260, the forces exerted on the clamp 260 by the connector body 100, the forces exerted between the angled surfaces 112 and 270 with the crushed outer conductor 306 buckled therebetween, the forces exerted on the connector body 100 by the compression member 200, the forces exerted on the cable jacket 312 by the grommet 220, and the forces exerted by the o-ring (not pictured) in the groove 106 on the inner surface of the compression member 200, add together to prohibit the connector assembly 10, once forced into the functionally engaged state, from being disassembled without excessive force. These retention forces can be enhanced by other known methods, such as adhesive, interlocking mechanical components, or the like. An additional benefit of the grommet 220 being compressed onto the jacket 312 include providing strain relief between the jacket 312 and the compression member 200, and providing added moisture sealing between the jacket 312 and the assembly 10.

As shown in FIG. 11, an additional embodiment of the assembly 10 in its first state is provided. The assembly 10 comprises, the compression member 200 having the grommet 220, the clamp ring 240, and the clamp 260 housed therein. The assembly 10 further comprises the connector body 100 having the spacer 140 and the pin 400 housed therein. In this particular embodiment, the spring basket 500 forms part of, and is integral with, the pin 400. The spacer 140, on the other hand, comprises a socket 148 that is configured to receive the basket 500 of the pin 400 under the condition that the assembly 10 is moved to its functionally engaged state. Once the socket 148 engages the basket 500, the socket 148 exerts pressure on the outer periphery of the basket 500 and causes the fingers 504 of the basket 500 to engage the inner conductor 302, in much the same way as described above. Thus, the inner conductor 302 is adequately and sufficiently electrically coupled to the basket 500, which is part of the pin 400, such that the inner conductor 302 is electrically coupled to the pin 400.

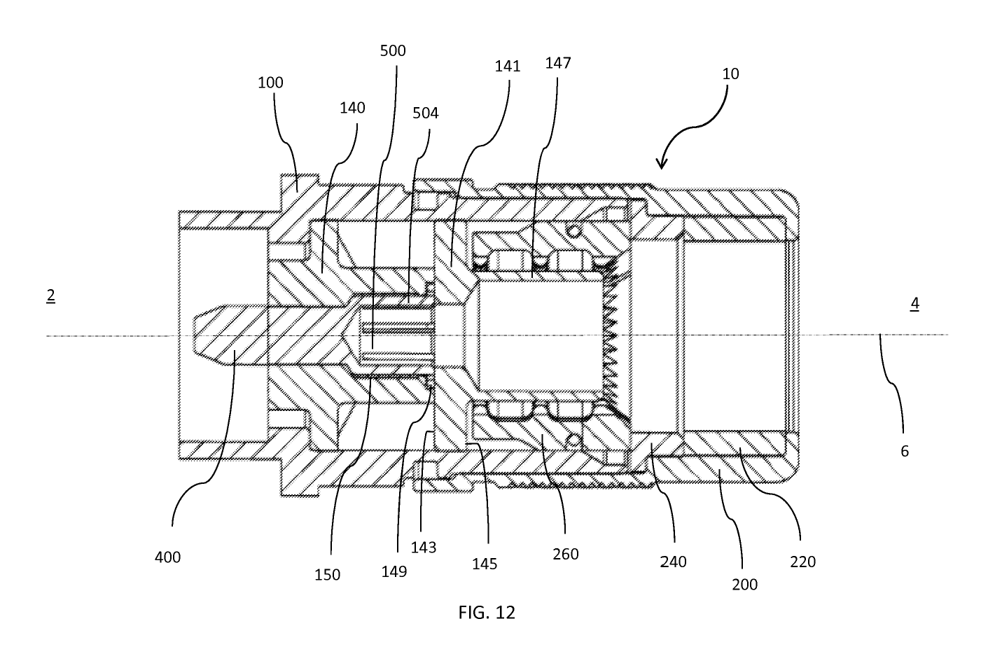

The spacer 140 is comprised of non-conductive material, which can generally be more flexible than conductive materials. To ensure that the spacer 140 provides the proper compressive pressure on the basket 500 and does not overly flex in response to the basket 500 being inserted into the spacer 140, a thin metal sleeve 150 lines the interior of the socket 148. The thin metal sleeve 150 is strong enough to ensure the structural integrity of the socket 148 and ensures that the socket 148 does not overly outwardly displace in response to the basket 500 being inserted therein. In other words, the thin metal sleeve 150 ensures that the socket 148 has a constant inner diameter so that the basket 500 and inner conductor 302 within the basket 500 can have a substantially constant outer diameter. In this way, under the condition that the assembly 10 is moved to its functionally engaged state, as shown in FIG. 12, the thin metal sleeve 150 retains its shape and exerts the proper compressive force on the basket 500 to ensure the proper compressive force is exerted by the fingers 504 of the basket 500 on the inner conductor 302.

Also, as shown in FIGS. 11 and 12, a secondary spacer 141 is positioned within the assembly 10 between the spring basket 500 and the clamp 260. The secondary spacer 141 is an annular ring having a first end 143 and a second end 145. The main ring of the secondary spacer 141, defined between the first end 143 and the second end 145, is adapted to slidably engage the inner surface of the connector body 100. The secondary spacer further comprises a tubular mandrel 147 extending axially from the second end 145. The tubular mandrel 147 has a diameter that is less than an inner diameter of the clamp 260, such that the tubular mandrel slides within the first end of the clamp 260. Under the condition that the coaxial cable 300 (not shown in FIGS. 11 and 12) is inserted into the assembly 10, the outer conductor 306 slides between the inner diameter of the clamp and the outer diameter of the tubular mandrel 147, which further insulates the inner conductor 302 from the outer conductor 306. The secondary spacer 141 further comprises an annular ridge 149 on the first end 143 of the secondary spacer 141. The secondary spacer 141 engages the fingers 504 of the spring basket 500 within the annular ridge 149 and axially displaces the spring basket 500 and pin 400 into the socket 148 on the first insulator 140 in response to compression forces that axially transition the assembly 10 from the first initial state, as shown in FIG. 11, to the functionally engaged state, as shown in FIG. 12.

Although a particular connection type, or interface, is disclosed as the forward end 2 of the assembly 10, the assembly 10 is not limited to this particular connection type/interface. For example, it is conceived that other connection types can be used in conjunction with the assembly 10, including, but not limited to, a DIN male connector interface, a BNC connector interface, a TNC connector interface, an F-type connector interface, an RCA-type connector interface, a DIN female connector interface, an N male connector interface, an N female connector interface, an SMA male connector interface, and an SMA female connector interface. As another example, a male or female version of the contact assembly 10 is conceived, as well as corresponding differences in connectors is conceived.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A coaxial cable connector assembly, the assembly comprising:
a compression member;
a connector body being adapted to engage the compression member in a first position;
a socket; and
a spring basket,
wherein under the condition that the compression member and the connector body are axially advanced toward one another from the first position to a second position, the spring basket engages an exposed inner conductor of a coaxial cable secured within the assembly and the socket engages the spring basket.

2. The coaxial cable connector assembly of claim 1, the spring basket further comprising:
flexible members extending axially along a length of the spring basket, the flexible members defining notches therebetween, the flexible members adapted to displace in response to the application of force by the socket.

3. The coaxial cable connector assembly of claim 2, further comprising:
a pin, the pin having a first end and a second end, the second end of the pin defining the socket;
an insulator, the insulator having a first end and a second end with a through bore therebetween, the throughbore slidably engaging the pin;
wherein axial advancement of the connector body results in the socket engaging the spring basket to flex the flexible members onto the inner conductor to grip the inner conductor.

4. The coaxial cable connector assembly of claim 2, further comprising:
a pin, the pin having a first end and a second end, the second end of the pin defining the spring basket; and
an insulator, the insulator having a first end, a second end, and a through bore therebetween, the through bore engaging the pin and the second end of the insulator defining the socket,
wherein axial advancement of the connector body results in the socket engaging the spring basket to flex the flexible members onto the inner conductor to grip the inner conductor.

5. The coaxial cable connector assembly of claim 4, further comprising:
a sleeve, the sleeve adapted to line the interior of the socket.

6. The coaxial cable connector assembly of claim 1, further comprising:
the connector body having a hollow interior;
a first compression surface on the interior of the connector body;
the compression member having a hollow interior;
a clamp positioned in the interior of the compression member, the clamp having a first end and a hollow interior, the first end defining a second compression surface; and
the coaxial cable having an exposed outer conductor, wherein the interior of the clamp engages the outer conductor,
wherein under the condition that the connector body and the compression member are axially advanced toward one another from the first position to the second position the first compression surface and the second compression surface compress therebetween the outer conductor.

7. The coaxial cable connector assembly of claim 6, wherein the outer conductor is compressed by buckling on itself between the first and second compression surfaces.

8. The coaxial cable connector assembly of claim 6, wherein the clamp is comprised of a plurality of identical and separate segments, the segments adapted to individually radially displace with respect to one another in response to the outer conductor passing therethrough and in response to compression forces action thereon.

9. A coaxial cable connector assembly, the assembly comprising:
a compression member;
a connector body being adapted to engage the compression member in a first position;
a socket;
a spring basket; and
means for engaging an exposed inner conductor of a coaxial cable secured within the assembly to the spring basket and the spring basket to the socket under the condition that the compression member and the connector body are axially advanced toward one another from the first position to a second position.

10. The coaxial cable connector assembly of claim 9, the means for engaging the inner conductor to the spring basket further comprising:
flexible members extending axially along a length of the spring basket, the flexible members defining notches therebetween, the flexible members adapted to displace in response to the application of force by the socket.

11. The coaxial cable connector assembly of claim 10, the means further comprising:
a pin, the pin having a first end and a second end, the second end of the pin defining the socket;
an insulator, the insulator having a first end and a second end with a through bore therebetween, the throughbore slidably engaging the pin;
wherein axial advancement of the connector body results in the socket engaging the spring basket to flex the flexible members onto the inner conductor to grip the inner conductor.

12. The coaxial cable connector assembly of claim 10, the means further comprising:
a pin, the pin having a first end and a second end, the second end of the pin defining the spring basket; and
an insulator, the insulator having a first end, a second end, and a through bore therebetween, the through bore engaging the pin and the second end of the insulator defining the socket,
wherein axial advancement of the connector body results in the socket engaging the spring basket to flex the flexible members onto the inner conductor to grip the inner conductor.

13. The coaxial cable connector assembly of claim 12, further comprising:
a sleeve, the sleeve adapted to line the interior of the socket.

14. The coaxial cable connector assembly of claim 9, further comprising:
the connector body having a hollow interior;
a first compression surface on the interior of the connector body;
the compression member having a hollow interior;
a clamp positioned in the interior of the compression member, the clamp having a first end and a hollow interior, the first end defining a second compression surface;
the coaxial cable having an exposed outer conductor, wherein the interior of the clamp engages the outer conductor; and
means for compressing the outer conductor between the first and second compression surfaces under the condition that the connector body and the compression member are axially advanced toward one another from the first position to the second position.

15. The coaxial cable connector assembly of claim 14, wherein the first and second compression surfaces are complimentary surfaces and the outer conductor is buckled on itself when compressed between the complimentary surfaces.

16. The coaxial cable connector assembly of claim 14, wherein the clamp is comprised of a plurality of identical and separate segments, the segments adapted to individually radially displace with respect to one another in response to the outer conductor passing therethrough and in response to compression forces action thereon.

17. A method of assembling a coaxial cable assembly, the method comprising:
placing a connector body and a compression member in a first assembled state;
axially advancing the connector body and the compression member toward each other to a second assembled state,
wherein axially advancing the connector body and the compression member results in a socket engaging a spring basket and the spring basket engaging an inner conductor of a coaxial cable secured within the assembly.

18. The method of claim 17, wherein axially advancing the connector body and the compression member toward each other results in compression of an outer conductor of the coaxial cable between opposing surfaces.

19. The method of claim 17, the method comprising:
preparing an end of the coaxial cable to be inserted into the assembly;
inserting the prepared end of the coaxial cable into the compression member;
securing the end of the coaxial cable within the compression member by engaging an outer conductor of the cable under a clamp engaged by the compression member, wherein as successive peaks and valleys of the outer conductor pass under the clamp, the clamp radially displaces to allow the outer conductor to pass thereunder.

20. The method of claim 19, wherein the clamp includes a plurality of segments that individually radially displace in response to force.
